(19) United States
(12) Patent Application Publication
(10) Pub. No.: US 2014/0258841 A1
(43) Pub. Date: Sep. 11, 2014

(54) METHOD OF BUILDING A CUSTOMIZABLE WEBSITE

(71) Applicant: SMUGMUG, INC., Mountain View, CA (US)

(72) Inventor: Brian STRONG, San Jose, CA (US)

(21) Appl. No.: 14/199,700

(22) Filed: Mar. 6, 2014

Related U.S. Application Data
(60) Provisional application No. 61/859,356, filed on Jul. 29, 2013.
(60) Provisional application No. 61/774,353, filed on Mar. 7, 2013.

(51) Int. Cl. G06F 17/22

(52) U.S. Cl. CPC G06F 17/2247
USPC 715/234

(57) ABSTRACT

The present invention generally relates to a method of building a customizable website. A website builder, a template comprising a plurality of content areas, and a plurality of content widgets are provided. The method also comprises receiving input selecting one or more content areas, receiving input selecting one or more content widgets, and receiving input of a selected content area for placement of the selected one or more content widgets.

### CROSS-REFERENCE TO RELATED APPLICATIONS

This application claims benefit of U.S. provisional patent application No. 61/774,353, filed Mar. 7, 2013, and U.S. provisional patent application No. 61/859,356, filed Jul. 29, 2013, both of which are hereby incorporated by reference.

### BACKGROUND

1. Field

Embodiments described herein generally relate to a method for building a website. More specifically, the embodiments described herein relate to a method of building a customizable website.

2. Description of the Related Art

The Internet has gained prevalence in today's society enjoyed by few other technologies. The backbone of the Internet is the almost countless number of websites that can be accessed from the Internet by users around the world. Many businesses and individuals maintain a website for business or personal use. However, creating a website generally requires the knowledge of computer code such as HTML, Java, Javascript, C, C++, Perl, PHP, Ruby, SQL, etc. Many businesses and individuals lack the requisite knowledge required to build a functioning website using code in a cost effective and timely manner. Moreover, the evolution of websites has resulted in a demand from website viewers that the websites function properly and are aesthetically pleasing.

Generally, a business or individual must hire a website designer or engineer with knowledge of computer code to construct and build a website to their desired specifications. Although the web designer or engineer may create a website that meets the specifications of the business or individual, any subsequent changes required by the business or individual would require further revision by the website designer or engineer. Each time the business or individual wants to make any changes to the website, they must pay for the changes which can decrease the cost-effectiveness of owning and maintaining a website. Further, for a business or individual who updates or changes their website frequently, it would be difficult to maintain a website with current information if the business or individual was not able to change and update the website themselves.

Moreover, even if an individual or business does have some knowledge of code and they attempt to build a website, the final result may be less than desirable. The aesthetics and functionality of the website may be lacking, which may further reduce the cost-effectiveness of owning and maintaining a website which is both functionally and aesthetically adequate. An improperly functioning or aesthetically lacking website may cause website viewers to avoid visiting the business or individuals' website.

Therefore, what is needed in the art is a customizable website which requires no knowledge of computer code to alter the website but results in a properly functioning and aesthetically pleasing website.

### SUMMARY

Embodiments described herein generally relate to a method of building a customizable website. A website builder, a template comprising a plurality of content areas, and a plurality of content widgets are provided. The method also comprises receiving input selecting one or more content areas, receiving input selecting one or more content widgets, and receiving input of a selected content area for placement of the selected one or more content widgets.

The aforementioned method allows a client to build a customizable website by using a website builder and a template. Content widgets may be placed into the content areas of the template with input received by the client. Certain embodiments allow content widgets to be placed directly into the content areas of the template or within containers disposed within the content areas of the template. The content widgets and containers may be customizable to allow for the client to create a customizable website.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a computer system configured for receiving input to build a customizable website;

FIG. 2 illustrates a more detailed view of a website building server of FIG. 1;

FIG. 3 illustrates a client computing system used to access the website building server and build a website;

FIG. 4 illustrates a customizable website building application;

FIG. 5A illustrates an input process of building a customizable website;

FIG. 5B illustrates a resulting product from the input process of building a customizable website of FIG. 5A;

FIG. 6A illustrates a first input process of building a customizable website;

FIG. 6B illustrates a resulting product from the first input process of building a customizable website of FIG. 6A and a second input process of building a customizable website;

FIG. 6C illustrates a resulting product from the second input process of building a customizable website of FIG. 6B; and

FIG. 7 illustrates a flow diagram of method steps for building a customizable website.

To facilitate understanding, identical reference numerals have been used, where possible, to designate identical elements that are common to the figures. It is contemplated that elements disclosed in one embodiment may be beneficially utilized in other embodiments without specific recitation.

### DETAILED DESCRIPTION

Embodiments described herein generally relate to a method of building a customizable website. A website builder, a template comprising a plurality of content areas, and a plurality of content widgets are provided. The method also comprises receiving input selecting one or more content areas, receiving input selecting one or more content widgets, and receiving input of a selected content area for placement of the selected one or more content widgets.

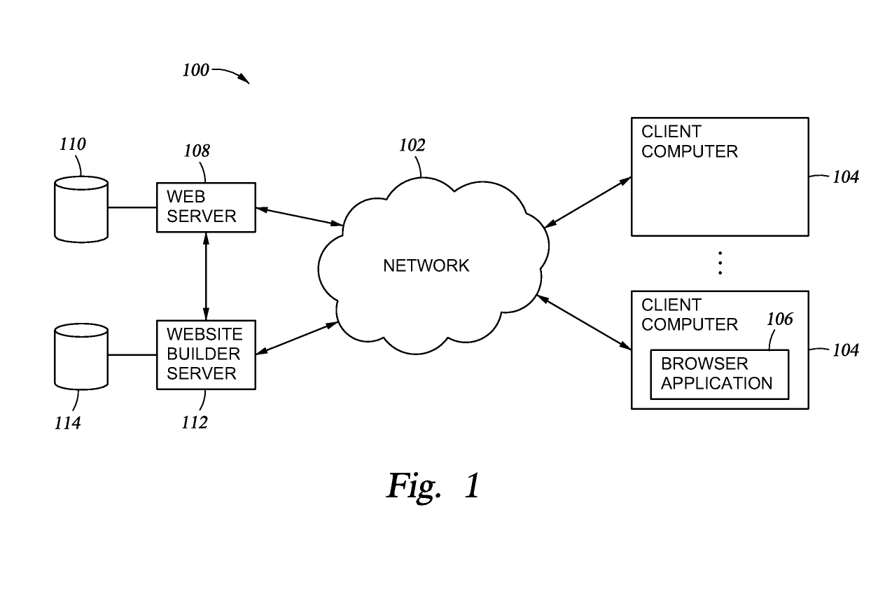

FIG. 1 illustrates a computer system configured for receiving input to build a customizable website. As shown, the computing system 100 may include a web server 108, a website building server 112, and a plurality of client computers 104 (only two of which are shown for clarity), each connected to a communications network 102 (e.g. the Internet). For example, the web server 108 may be programmed to communicate with the client computers 104 and the website building server 112 using a networking protocol such as TCP/IP protocol. The website building server 112 may communicate directly with the client computers 104 through the communications network 102.

Each client computer 104 may include conventional components of a computing device, e.g., a processor, system memory, a hard disk drive, input devices such as a mouse and a keyboard, and/or output devices such as a monitor, and/or a combination input/output device such as a touchscreen which not only receives input but also displays an output. The web server 108 and the website building server 112 may include a processor and a system memory (not shown), and may be configured to manage web pages and other media content stored in its respective content storage unit 110 and 114 using a file system and/or relational database software. The website building server 112 may be a web server configured to manage website building tools and content stored in its respective content storage unit 114. The website building server 112 may be configured to receive input from a client and enable the client to build a customizable website utilizing techniques described herein and is described in further detail below.

In the embodiments described below, clients are respectively operating the client computers 104 that may communicate over the network 102 to request webpages and other media content data from the website building server 112. Each client computer 104 may be configured to execute a software application, such as a browser application 106, and access webpages and/or media content data managed by the website building server 112 by specifying a uniform resource locator (URL) for the website building server 112 into the web browser application 106. The webpages that are displayed to a client may be transmitted from the website building server 112 to the client's computer 104 and processed by the web browser application 106 for display through a monitor of the client's computer 104.

A webpage displayed to the client on the client's computer 104 is the client's own website. The client's computer 104 may access the website building server 112 which, in turn, retrieves the client's website from storage 114, and causes the client's website to be shown through the browser 106 on the client's computer 104. The client's website may be managed by the client with a username and password combination, or other similar restricted access/verification required access methods, which allow the client to “log in” and make changes within the website. Changes or alterations made by the client to their website on the client computer 104 may be transmitted through the communications network 102 to the website building server 112. The website building server 112 may transfer the client's website to storage 114 where it may be retrieved and viewed by any other users with access to the Internet.

It is noted that the client computer 104 may be a personal computer, laptop, mobile computing device, smart phone, video game console, home digital media player, network-connected television, set top box, and/or other computing devices having components suitable for communicating with the communications network 102. The client computer 104 may also execute other software applications configured to receive website building content from the website building server 112, such as, but not limited to, media display software, media players, computer and video games, and/or widget platforms.

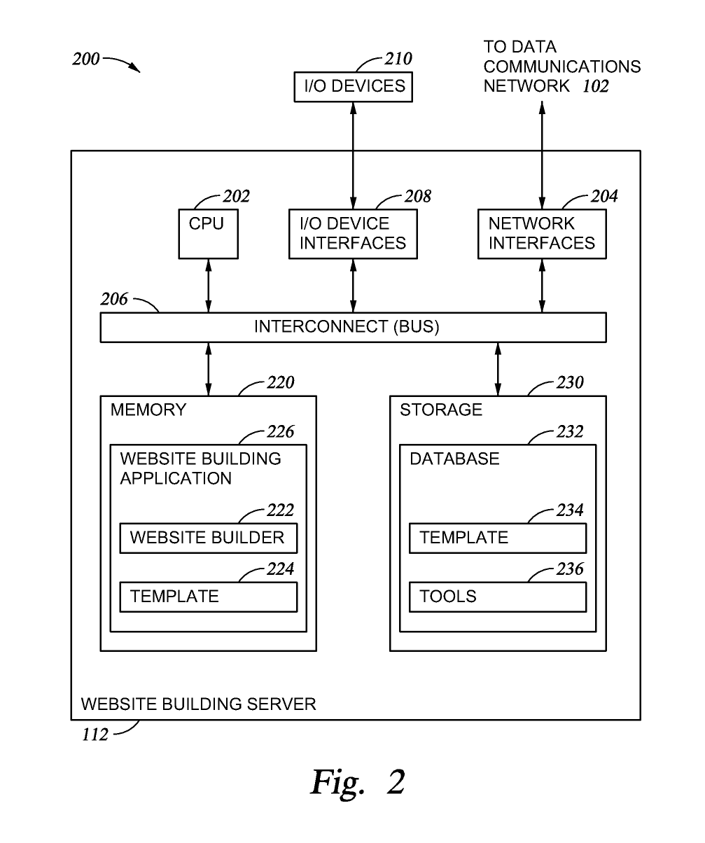

FIG. 2 illustrates a more detailed view of a website building server 112 of FIG. 1. The website building server 112 includes, without limitation, a central processing unit (CPU) 202, a network interface 204, memory 220, and storage 230 communicating via an interconnect bus 206. The website building server 112 may also include I/O device interfaces 208 connecting I/O devices 210 (e.g. keyboard, video, mouse, audio, touchscreen, etc). The website building server 112 may further include a network interface 204 configured to transmit data via the communications network 102.

The CPU 202 retrieves and executes programming instruction stored in the memory 220 and generally controls and coordinates operations of other system components. Similarly, the CPU 202 stores and retrieves application data residing in the memory 220. The CPU 202 is included to be representative of a single CPU, multiple CPU's, a single CPU having multiple processing cores, and the like. The interconnect 206 is used to transmit programming instructions and application data between the CPU 202, I/O device interfaces 208, storage 230, network interface 204, and memory 220.

The memory 220 is generally included to be representative of a random access memory and, in operation, stores software applications and data for use by the CPU 202. Although shown as a single unit, the storage 230 may be a combination of fixed and/or removable storage devices, such as fixed disk drives, floppy disk drives, hard disk drives, flash memory storage drives, tape drives, removable memory cards, CD-ROM, DVD-ROM, Blu-Ray, HD-DVD, optical storage, network attached storage (NAS), or a storage area-network (SAN) configured to store non-volatile data.

The memory 220 may store instructions and logic for executing a website building application 226. The website building application 226 may include a website builder 222 and a template 224, among other applications. The storage 230 may store website building content and may include a database 232 configured to store data for building a website according to techniques described herein, such as a plurality of website templates 234 and a plurality of tools 236. The database 232 may also store data relating to previously created websites by a client which may be easily accessed by the client when the client is editing their website. The database 232 may be any type of storage device.

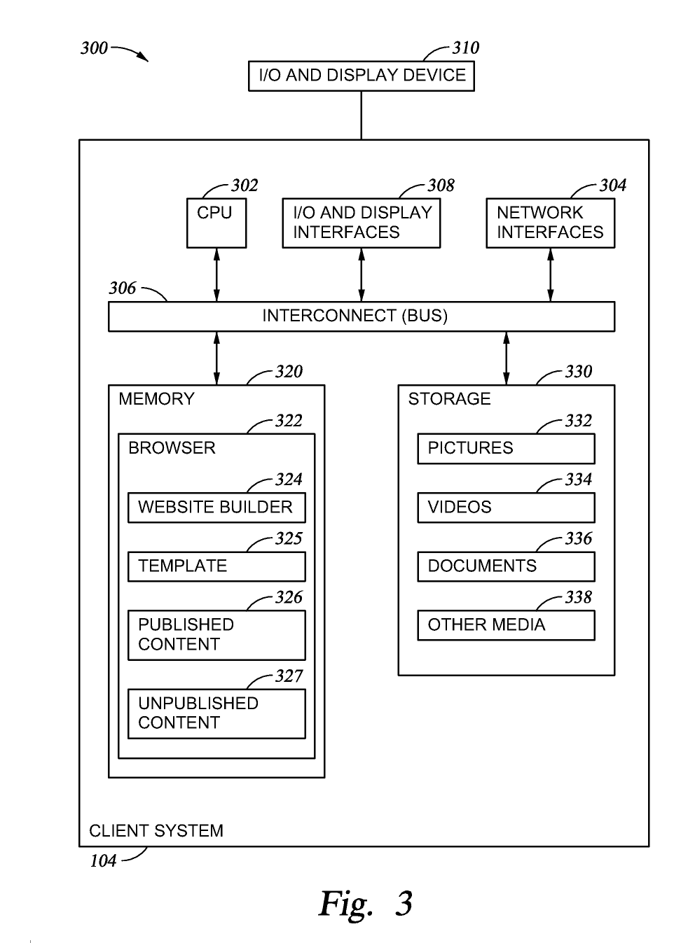

FIG. 3 illustrates a client computing system used to access the website builder server and build a website. The client computing system 104 may include, without limitation, a central processing unit (CPU) 302, a network interface 304, an interconnect 306, a memory 320, and storage 330. The computing system 104 may also include an I/O device interface 308 connecting I/O devices 310 (e.g. keyboard, display, touchscreen, and mouse devices) to the computing system 104.

Like CPU 202, CPU 302 is included to be representative of a single CPU, multiple CPU's, a single CPU having multiple processing cores, etc., and the memory 320 is generally included to be representative of a random access memory. The interconnect 306 may be used to transmit programming instructions and application data between the CPU 302, I/O device interfaces 208, storage 330, network interface 304, and memory 320. The network interface 304 may be configured to transmit data via the communications network 102, e.g. to stream content from the website building server 112, as well as to receive and present the client's website in a published or editable format from the website building server 112. Storage 330, such as a hard disk drive or solid-state storage drive (SSD), may store non-volatile data. The storage 330 may contain pictures 332, videos 334, documents 336, and other media 338 which can be any type of media that may be published to a website. Illustratively, the memory 320 may include a web browser 322, which itself displays a website builder 324, a template 325, published content 326, and in certain embodiments, unpublished content 327. The browser 322 may provide a software application which allows the client to access web pages and other content hosted by the website building server 112. The browser 322 may also allow any user of the client computer system 104 to access any website available on the Internet.

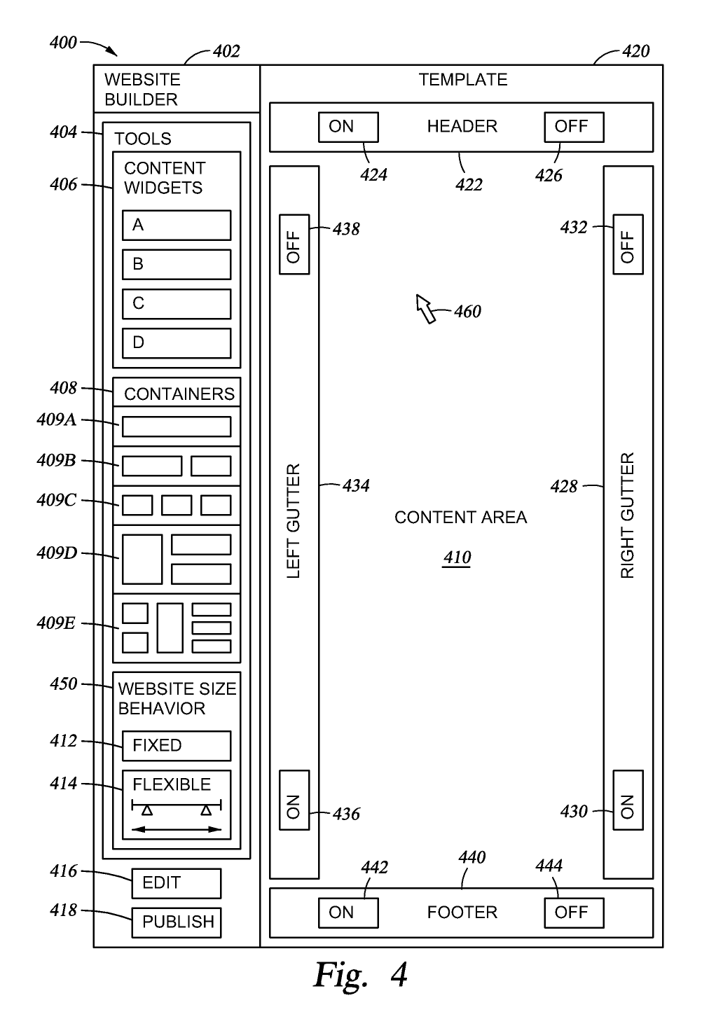

FIG. 4 illustrates a customizable website building application 400. The customizable website building application 400 comprises a website builder 402 and a template 420. The website builder 402 and template 420 may be provided by the website building server 112 through the communications network 102 to the client computer system 104 as previously described. The website builder 402 and template 420 may be displayed via an I/O device which allows the client to interact with the website builder 402 and template 420 to create a customizable website. The website may be customized by providing input and selections to the website builder 402 and the template 420 to create a customizable website. An input selection member, illustratively shown as a cursor 460, may be provided which may be moved across an I/O display device upon which the website builder 402 and template 420 are displayed. The cursor 460 may be moved by the client with a traditional I/O device such as a mouse or a trackpad and the cursor 460 may be adapted to indicate the client's input or selection within the website building application 400. The cursor 460 may also represent a client's tactile input, such as a client's finger, contacting a touch enabled device.

The website builder 402 and template 420 are depicted in FIG. 4 as being displayed as a webpage during editing by the client. Although shown as being displayed in a fixed position, the website builder 402 may be moved by input provided by the client to occupy different areas of the website building application 400. The website builder 402 and the template 420 may also be layered upon each other. For example, the template 420 may be displayed across an entire webpage within the website building application 400 and the website builder 402 may be layered over at least a portion of the webpage on top of the template 420. The website builder 402 may be visible in a layer above the template 420. The website builder 402 may also be somewhat transparent or translucent and the client may be able to view portions of the template 420 layer under the website builder 402. The transparent or translucent nature of the website builder 402 allows the client to see changes being made and applied by the website builder 402 to the template 420 to appear in real time. Thus, the layered structure of the website builder 402 and the template 420 may reduce or eliminate the need for the client to publish the webpage to view changed implemented by the client.

In addition, the application 400 may determine the size of the browser window and automatically display the website builder 402 in the most ideal region for use by the client. For example, if the browser is provided in a substantially landscape orientation, the website builder 402 may appear toward the left or right portions of the browser. In another example, if the browser is provided in a substantially portrait orientation, the website builder 402 may appear toward the top or bottom of the browser. Dynamically selecting the location of display of the website builder 402 increases the viewable portion of the underlying template 420.

The website builder 402 may comprise various menus or selections. As such, a client may provide input selecting a menu option which may cause some action to be performed in the template 420. Upon selecting the menu option, the menu and/or the website builder 402 may automatically minimize or disappear so that the template 420 may occupy the majority of or all of the client's browser. The client may provide various inputs or selection within the template 420 to further customize the template 420. When the client has finished providing inputs to the template 420, the website builder 402 menu options may automatically reappear or maximize from a minimized state. Thus, the transition between website builder 402 and template 420 is more seamless and cerebral and the client may more efficiently build and design their website.

The template 420 comprises a plurality of template areas that may be customized with input or selections provided by the client. The template 420 may be configured to provide, but is not limited to, a header 422, a footer 440, a left gutter 434, a right gutter 428, and a content area 410. The header 422, footer 440, and left and right gutters 434 and 428 may provide ON/OFF designations configured to be selected with input provided from the client. The client may select OFF 426 for the header 422 and OFF 444 for the footer 440, which would hide both the header 422 and the footer 440 from view in the template 420. The client may select OFF 438 for the left gutter 434 and OFF 432 for the right gutter 428, which would hide both the left gutter 434 and the right gutter 428 from view in the template 420. The client may select ON 424 for the header 422, ON 442 for the footer 440, ON 436 for the left gutter 434, and ON 430 for the right gutter 428, which would show the header 422, footer 440, left gutter 434, and right gutter 428 when viewing the template 420. It should be understood that any combination of ON/OFF selections may be made by the client with regard to the header 422, footer 440, left gutter 434, and right gutter 428 to allow the template 420 to be customized by the client in any manner desired.

The content area 410 of the template 420 may be configured to receive content from inputs or selections provided by the client. The content area 410 may be configured in any manner desired by the client. Boundaries of the content area 410 are generally formed by the header 422, footer 440, left gutter 434, and right gutter 428, regardless of whether the header 422, footer 440, left gutter 434, and right gutter 428 are shown or hidden based on input provided by the client. The client may utilize the website builder 402 and the tools 404 contained therein to customize the content area 410 of the template 420.

The template 420 may comprise an organic layout function. An organic layout function may define a template 420 layout configured to retain a plurality of preset proportions by continually adjusting the content embedded within the template 420 to conform with the plurality of preset proportions. The organic layout function may be an algorithm provided by a website building application host which may be applied to the client's website in order to ensure functionality and a desirable aesthetic appearance of the website. The organic layout function may apply to specific content within the template 420 or the entire contents of the website. Although the client has complete control over the content included in the website, the organic layout function may apply when the customized website is published to improve the overall functionality and aesthetic value of the website. The overall purpose of the of organic layout function is to provide a more cerebral, or “human,” website layout and structure that increases intuitiveness of the website from a client's perspective and ultimately leads to increased aesthetic quality and ease of use.

The website builder 402 may provide a plurality of selections to enable the client to customize the website, such as an EDIT 416 selection and a PUBLISH 418 selection. If the client desires to change or alter the template 420 using the website builder 402, the client may provide input selecting the EDIT 416 selection. The EDIT 416 selection allows the client to customize the website with the website builder 402 in any manner desired. Changes made to the website by the client while editing the website may be saved automatically to the website building server 112 or may be saved to the website building server 112 with input provided by the client. In either example, the changes made during editing are not visible to visitors of the website until the client provides input to the PUBLISH 418 selection. The PUBLISH 418 selection transmits the final customized website from the client computer 104 through the communications network 102 to the website building server 112 where the client's website may be searched and accessed through the Internet.

The website builder 402 provides a plurality of tools 404 which allow the client to alter the template 420. One of the plurality of tools 404 provided may be a plurality of content widgets 406. The content widgets 406 may contain content that may be embedded and displayed in the content area 410 of the template 420. Content widgets 406 may also be provided to the header 422, footer 440, left gutter 434, and right gutter 428 in addition to the content area 410. The content widgets 406 may be embedded by client input, such as a drag-and-drop input. A drag-and-drop input is provided as an illustrative input and should not be considered limiting as various other methods of embedding information may be performed to satisfy a client input. The drag-and-drop input may be performed by the client by using the cursor 460 shown in the browser to select the desired content widget 406. It should be known that the cursor 460 is provided as an illustrative embodiment and should not be considered limiting. Other selection apparatuses, such as a client's finger when using a touch sensitive I/O device, may function in the same manner as the cursor 460. However, the traditional “cursor and mouse” approach as depicted in the Figures is discussed so as to not obscure the invention.

The client may move the cursor 460 over the desired content widget 406 and depress a selection button of an I/O device, such as a mouse or a trackpad. While the selection button is depressed, the client may drag the selected content widget 406 from the website builder 402 to the template 420 and drop the content widget 406 in the desired part of the content area 410 of the template 420 by releasing the selection button of the I/O device. Upon being dropped into the content area 410, the content widgets 406 may form a structure in the template 420. The content widgets 406 may also be rearranged within the template 420 or removed from the template 420 with input provided by the client.

Examples of content widgets 406 may include, but are not limited to, picture or photograph applications, video applications, slide show applications, site visit counting applications, site search applications, maps and location applications, social media applications such as Facebook, Twitter, Tumblr, Yelp, and Groupon, and other applications which may contain content to be displayed on the client's website. The content widgets 406 may be applications created by the host of the website building server, the content widgets 406 may be applications created by a third party, or the content widgets 406 may be applications created by the client.

Another example of one of the plurality of tools 404 in the website builder 402 may be a container tool 408. A container may be an object within which a widget will be placed. The container may be disposed in a location on the webpage determined by the client. Additionally, the widget may be selected by the client and placed in the container. Various shapes and sizes may be used for the containers. The container tool 408 provides various containers and may be configured to receive input selecting a container or combination of containers. The containers 409A-409E may be building blocks adapted to create a structure within the content area 410 of the template 420. It should be understood that any shape or other structure may form a container, but that rectangles and squares are shown as to not obscure the invention. The containers 409A-409E may also be adapted to receive content, such as content widgets 406, once the containers 409A-409E are placed in the content area 410 of the template 420. Similar to the content widgets 406, the containers 409A-409E may be placed into the content area 410 of the template 420 via a drag-and-drop input provided by the client. In one example, once the containers 409A-409E are placed in the content area 410, the dimensions of the containers 409A-409E are fixed. In another example, the dimensions of the containers 409A-409E are flexible and may be adjusted with input provided by the client. Upon being dropped into the content area 410, the containers 409A-409E may be rearranged within the template 420 or removed from the template 420 with input provided by the client.

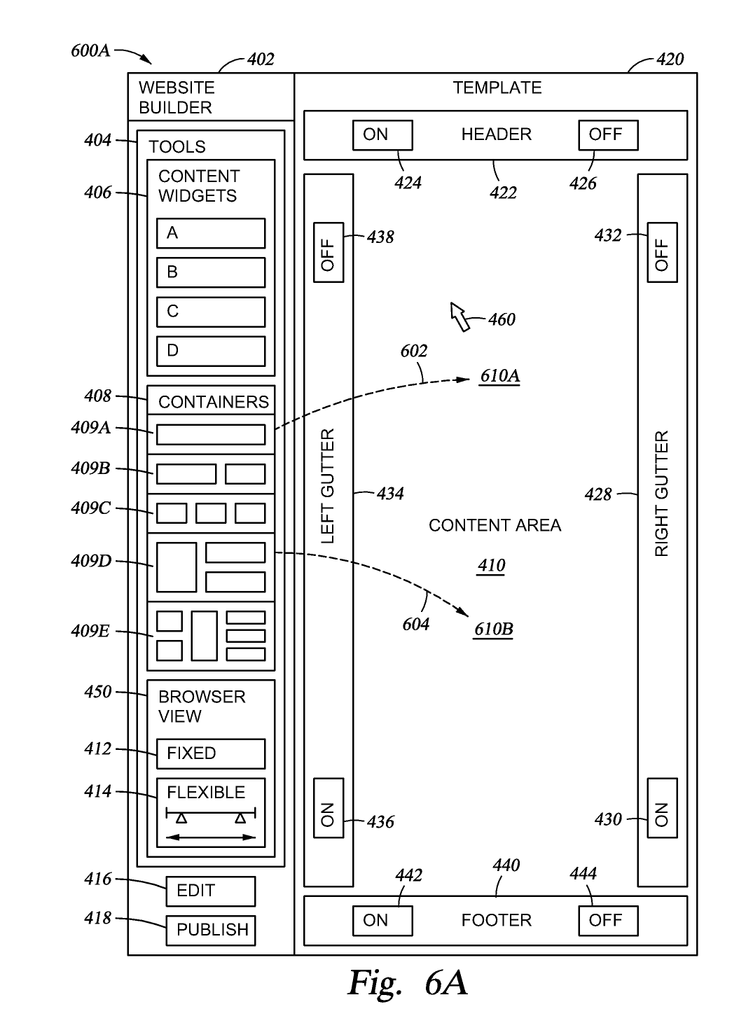

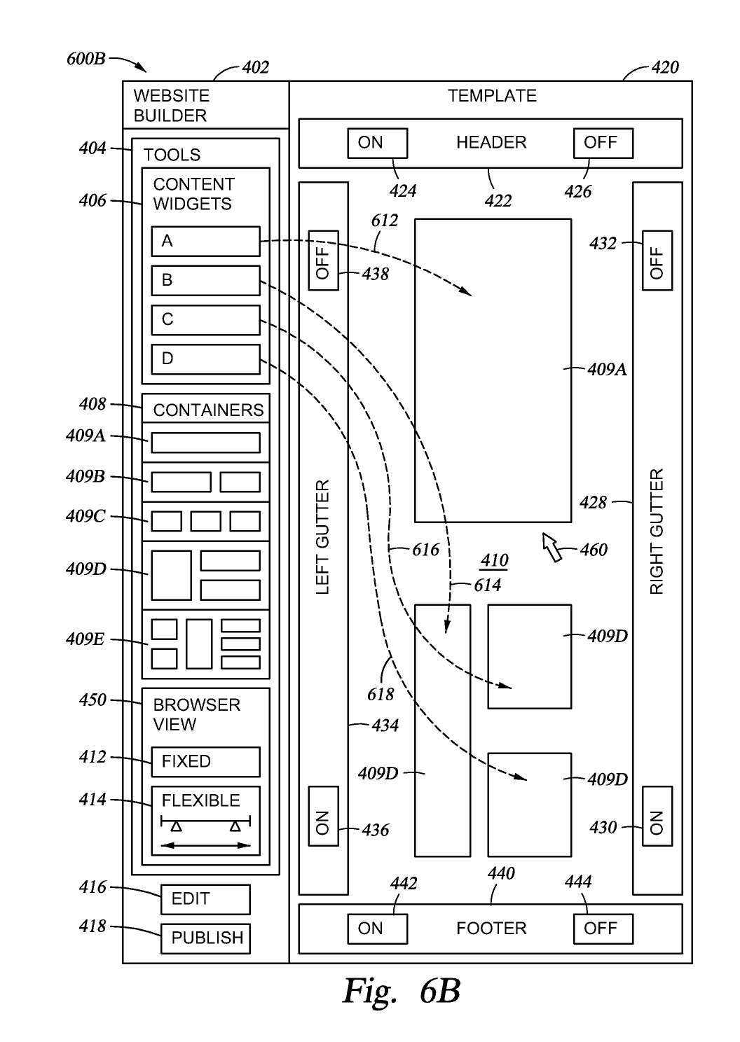

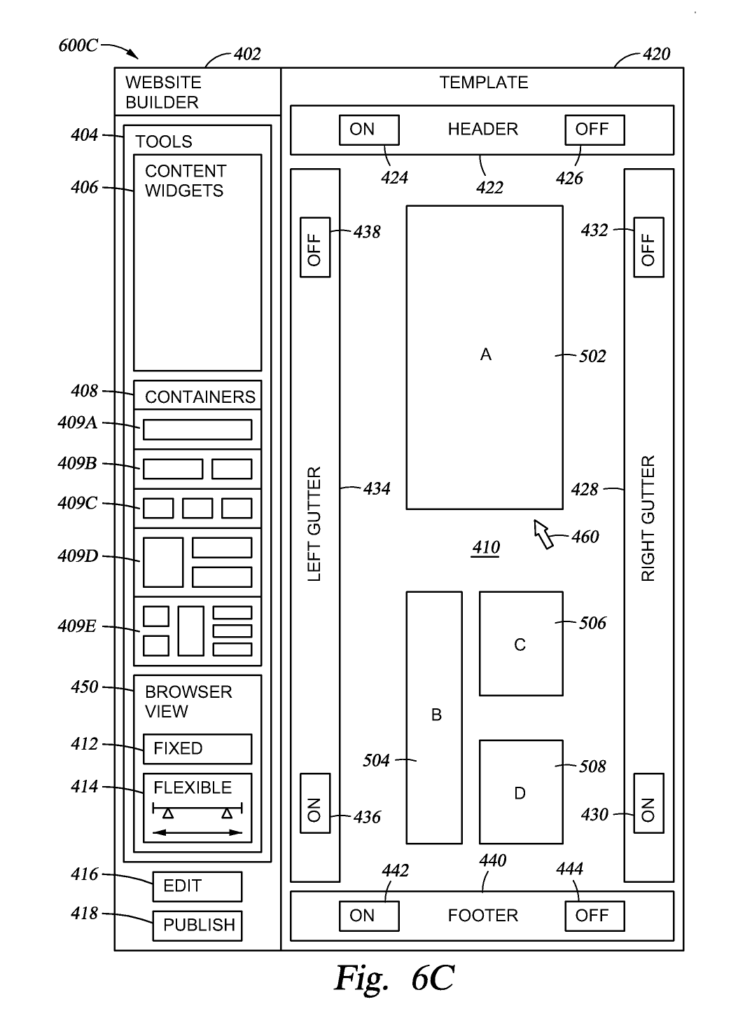

A container may be a single container, such as container 409A. A container may also be a set of containers, such as containers 409B, 409C, 409D, and 409E. The container or set of containers 409A-409E, may configured to structure the entire content area 410. In another example, the container or set of containers 409A-409E may be configured to structure a portion of the content area 410. As depicted in FIG. 6B, combinations of the container or set of containers 409A-409E may be combined to structure the entire content area 410.

Another one of the plurality of tools 404 may be a website size behavior tool 450. The website size behavior tool 450 comprises a fixed size application 412 and a flexible size application 414. The website size behavior tool 450 generally receives input from the client and determines how the client's website will be displayed to a viewer using an Internet browser application. Examples of browser application that may be used to view the client's website include, but are not limited to, Internet Explorer, Safari, Google Chrome, and Mozilla Firefox, among others. The website size behavior tool 450 provides the client with the ability to control how the website will be displayed when viewed by a viewer using various browser applications in combination with various screen sizes of I/O display devices.

The client may provide input to the website size behavior tool 450 selecting the flexible size application 414. The flexible size application 414 may establish a flexible size, such as the size of the width or height, of the website when it is viewed in a browser application. The client may determine the desired size by providing input selecting a variable number of pixels from a vertical and/or horizontal edge of a viewer's browser application. Because the client generally will not have control over what type of browser application a viewer may use, the flexible size application 414 allows the client to select a size at which the client's website will be displayed regardless of the type of browser application used by the viewer. For example, the client may provide input selecting 10 pixels from both the left and right vertical edges of the viewer's browser application. In this example, the website will always be displayed with a width 10 pixels from both the left and right vertical edges of the viewer's browser application, regardless of the width of the browser application as displayed on the viewer's I/O display device. The aforementioned example would also similarly apply with regard to the height of the website and the client may choose to control both the width and height of the website by using the website size behavior tool 450. The flexible size application 414 allows the client's website to be displayed in a manner that adapts to the various dimensions of a viewers browser application being displayed on various I/O display devices.

The client may also provide input to the website size behavior tool 450 selecting the fixed size application 412. The fixed size application 412 may establish a fixed size of the website when viewed in a browser application. The client may provide input to the fixed size application 412 which causes the website to be displayed at a size desired by the client. The size of the website will not change or adapt based on the dimensions of a viewer's browser application. This example allows the client to ensure their website will always be viewed at the size selected by the client, regardless of the various dimensions of the viewer's browser application being displayed on various I/O display devices. Similar to the example above concerning the flexible size application 414, the fixed size application 412 may control both the width and height of the website to be displayed.

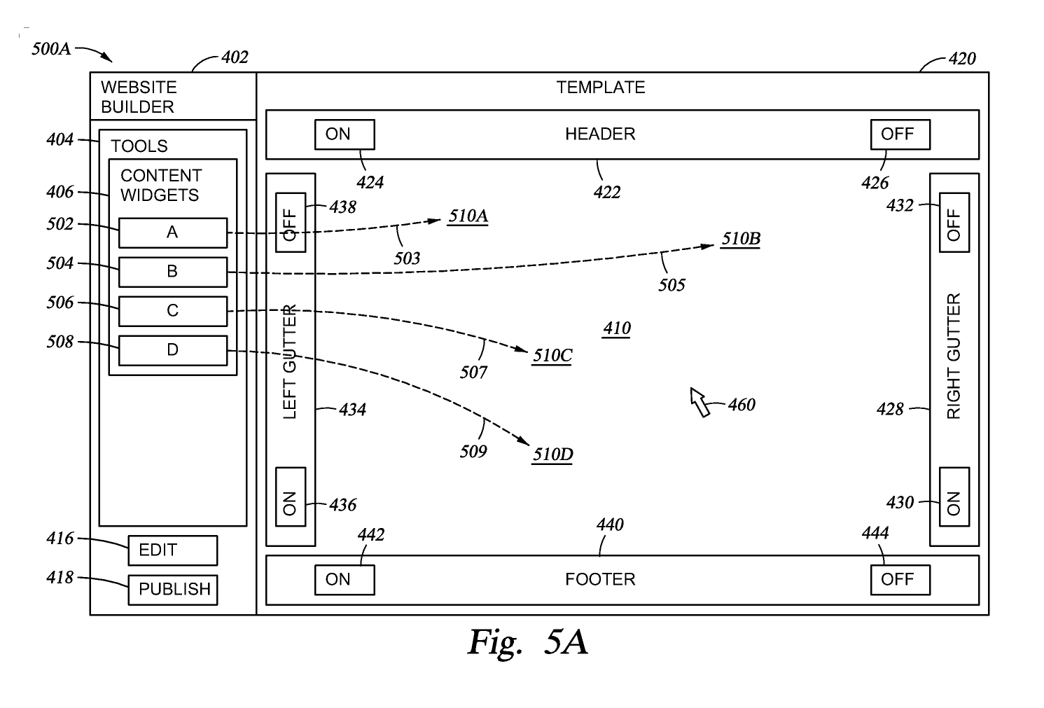

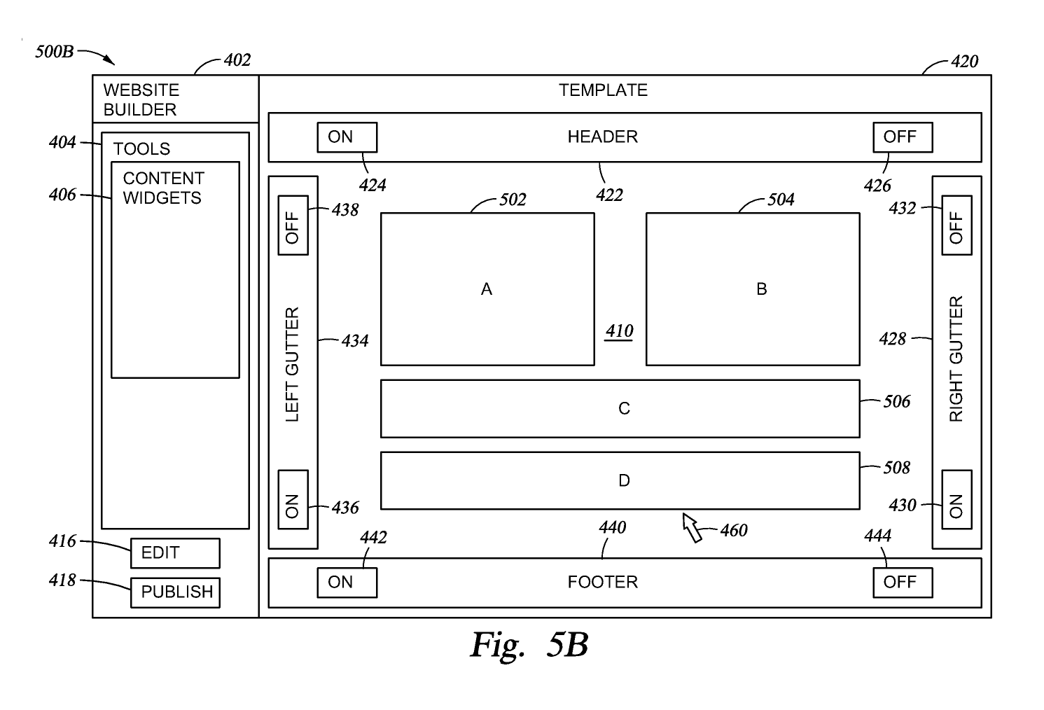

FIG. 5A illustrates an input process of building a customizable website. The customizable website building application 500A illustrates an exemplary input process performed by a client to create a customizable website. The website builder 402 and template 420 may be similar to the website builder 402 and template 420 of FIG. 4. Previously shown and described tools 404, such as the container tool and website size behavior tool are not shown for the sake of clarity. If the client desires to alter or change their website, the client may provide input, such as by utilizing the cursor 460 as previously described, selecting the EDIT 416 selection. Upon selecting EDIT 416, the client may freely customize the website. When the client has finished editing the website, the client may select PUBLISH 418 to disable further editing and publish the website to the Internet.

Content widgets 406 may comprise any type of widget as previously described. For clarity, content widgets have been identified as A 502, B 504, C 506, and D 508. The client may customize the template 420 by providing input, such as a drag-and-drop input as described above, selecting desired content widgets 406 to be embedded within the template 420. As shown, the client may provide a multiplicity of drag-and-drop inputs 503, 505, 507, and 509 to embed a plurality of content widgets 502, 504, 506, and 508 into the content area 410 of the template 420. The content area 410 may be configured to receive the plurality of content widgets 502, 504, 506, and 508 via the multiplicity of drag-and-drop inputs 503, 505, 507, and 509.

For example, the client may provide content widget A 502 via drag-and-drop input 503 to a first desired location 510A within the content area 410. The client may further provide content widget B 504 via drag-and-drop input 505 to a second desired location 510B within the content area 410. Still further, the client may provide content widget C 506 via drag-and-drop input 507 to a third desired location 510C within the content area 410. Finally, the client may provide content widget D 508 via drag-and-drop input 509 to a fourth desired location 510D within the content area 410. It should be understood that the locations 510A-D within the content area 410 are provided as an example, are not predefined, and should not be construed as limiting the customizability of the customizable website building application 500A.

FIG. 5B illustrates a resulting product from the input process of building a customizable website of FIG. 5A. In the embodiment shown, the inputs provided by the client with regard to FIG. 5A result in the content area 410 structure containing embedded content widgets A 502, B 504, C 506, and D 508. Locations 510A-510D of FIG. 5A now contain and display the embedded content widgets 502, B 504, C 506, and D 508, respectively. The embedded content widgets 502, B 504, C 506, and D 508 may define the structure of the content area 410. The structure may be rigid or may be further customizable with input provided by the client. For example, the client may desire for content widget A 502 to be narrower than shown and for content widget B 504 to be wider than shown. The client may scale the size of the content widgets A 502 and B 504 to achieve the desired structure within the content area 410. In this example, the content widget will be scaled to adapt to the structure designed by the client.

The client may also desire to change the location or remove the content widgets 502, B 504, C 506, and D 508 from the content area 410. In this example, the structure formed by the content widgets 502, B 504, C 506, and D 508 may adapt to the input provided by the client. In another example, the client may provide input adding another content widget (not shown), in which case the structure of the content area 410 may adapt to accommodate the additional content widget and scale the existing content widgets 502, B 504, C 506, and D 508 accordingly to account for the space required by the additional content widget. It should be understood that the structure of the content area 410 and content widget 406 location and dimensions may be freely altered within the template 420 in any desired manner with input provided by the client.

Additionally, it is to be understood that while the description has been made with regards to placing content widgets into a content area, embodiments discussed herein are applicable to situations where no defined content area exists, but rather, placing the widget into a specific place creates a content area. For example, a blank layout for a webpage may be present with no defined content areas other than the plain, undefined webpage itself. Then, any widget may be placed anywhere on the webpage. By so placing the widget, the content area for the widget is defined based upon the size/shape of the widget.

FIG. 6A illustrates a first input process of building a customizable website. The customizable website building application 600A illustrates another exemplary input process performed by a client to create a customizable website. The website builder 402 and template 420 may be similar to the website builder 402 and template 420 of FIG. 4. If the client desires to alter or change their website, the client may provide input, such as by utilizing the cursor 460 as previously described, selecting the EDIT 416 selection. Upon selecting EDIT 416, the client may freely customize the website. When the client has finished editing the website, the client may select PUBLISH 418 to disable further editing and publish the website to the Internet.

The container tool 408 may provide a plurality of containers 409A, 409B, 409C, 409D, and 409E. The containers 409A-E may comprise any shape or structure as previously described. For clarity, the containers 409A-E have been shown as a combination of rectangles and squares so as to not obscure the invention. The client may customize the template 420 by providing input, such as a drag-and-drop input as described above, selecting containers 409A-E to be embedded within the template 420.

As shown, the client may provide a multiplicity of drag-and-drop inputs 602 and 604 to embed a plurality of containers 409A-E into the content area 410 of the template 420. The content area 410 may be configured to receive the plurality of containers 409A-E via the multiplicity of drag-and-drop inputs 602 and 604. For example, the client may provide container 409A via drag-and-drop input 602 to a first desired location 610A within the content area 410. The client may further provide container 409D via drag-and-drop input 604 to a second desired location 610B within the content area 410. It should be understood that the locations 610A-610B within the content area 410 are provided as an example, are not predefined, and should not be construed as limiting the customizability of the customizable website building application 600A. Further, any combination of containers 409A-E may be provided via multiple drag-and-drop inputs to customize the template 420 into a structure desired by the client.

FIG. 6B illustrates a resulting product from the first input process of building a customizable website of FIG. 6A and a second input process of building a customizable website. As shown, container 409A formed a template structure upon being embedded within the template 420. Similarly, container 409D formed a template structure upon being embedded within the template 420. Generally, containers may be configured to receive content widgets 406 upon being embedded within the template 420. The containers may also be scalable in size to satisfy the demands of the client in building a customizable website. Thus, the containers 409A and 409D may form a structure in the template 420. With a structure formed in the template 420, the client may desire to embed content widgets 406 within the containers 409A and 409D. It should be understood that any container provided by the container tool 408 forming a template structure may receive any type content widget 406.

To provide content to the containers 409A and 409D, the client may provide input, such as a drag-and-drop input, selecting a plurality of content widgets 406 to be embedded within the structure formed by the containers 409A and 409D in the content are 410. For example, the client may provide content widget A 502 via drag-and-drop input 612 to container 409A within the content area 410. The client may further provide content widget B 504 via drag-and-drop input 614 to container 409D within the content area 410. The client may further provide content widget C 506 via drag-and-drop input 616 to container 409D within the content area 410. Finally, the client may provide content widget D 508 via drag-and-drop input 618 to container 409D within the content area 410.

FIG. 6C illustrates a resulting product from the second input process of building a customizable website of FIG. 6B. As shown, the content widgets A 502, B 504, C 506, and D 508 may be embedded in the containers 409A and 409D (not shown), respectively. The content widgets A 502, B 504, C 506, and D 508 embedded in their respective containers 409A and 409D may automatically scale to fit the size of the container in which they were embedded.

In a general embodiment, the containers with embedded content widgets may be altered to further improve the customization of the website with input provided by the client. Examples of further customization may include, changing the location of the container containing the content widget within the template or altering the size of the container containing the content widget within the template. Other examples may include adding or removing content widgets or containers to satisfy the demands of the client building the website.

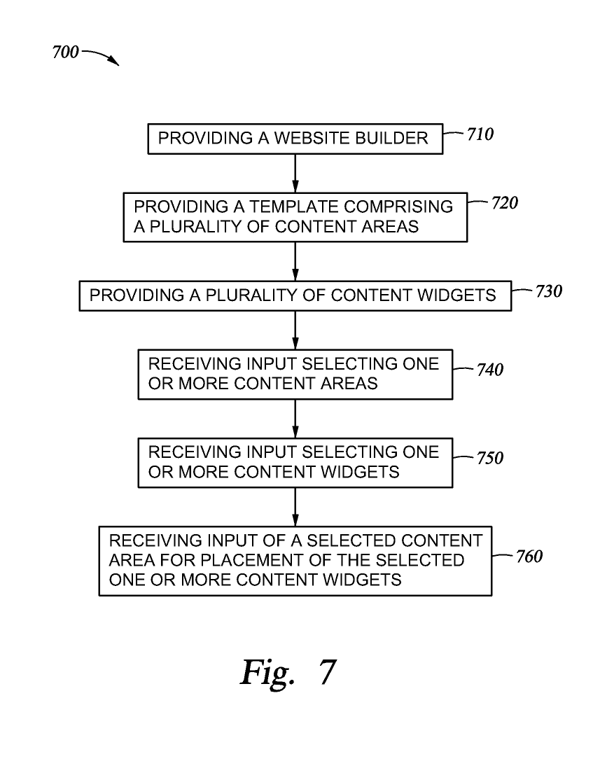

FIG. 7 illustrates a flow diagram of method steps for building a customizable website. The method 700 of building a customizable website begins at step 710 by providing a website builder. The website builder comprises a plurality of tools configured to receive input provided by a client to build a customizable website. Next, step 720 provides a template comprising a plurality of content areas. The template may be configured to be altered or changed in a customizable manner by the website builder with input provided by the client. The template may also be altered or changed directly with input provided by the client.

Next, at step 730, a plurality of content widgets is provided. The content widgets may be provided by a content widget tool and generally contain content to be embedded within the content areas of the template. The content widgets may contain any type of content as previously described. At step 740, input selecting one or more content areas may be received. The selection of the content areas may be accomplished with input from the client providing containers to the content areas of the template. The containers may be configured to structure the content areas of the template and are further configured to receive content widgets. Next, at step 750, input selecting one or more content widgets may be received. The content widgets may be selected with input provided by the client and may be configured to be embedded directly into the content areas of the template or into containers embedded in the content areas of the template.

Finally, at step 760, input of a selected content area for placement of the selected one or more content widgets may be received. Input provided by the client may perform steps 740, 750, and 760 simultaneously. Alternatively, steps 740, 750, and 760 may performed independently with input provided by the client. However, both examples result in content widgets embedded in the content area of the template.

While the foregoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention. Therefore, the scope of the present invention is determined by the claims that follow.

1. A method of building a customizable website, comprising:
providing a website builder;
providing a template comprising a plurality of content areas;
providing a plurality of content widgets;
receiving input selecting one or more content areas;
receiving input selecting one or more content widgets; and
receiving input of a selected content area for placement of the selected one or more content widgets.

2. The method of claim 1, wherein the website builder comprises a plurality of tools adapted to configure the template and the content areas.

3. The method of claim 2, wherein at least one of the plurality of tools comprises a content widget tool adapted to embed content widgets within the content areas of the template.

4. The method of claim 3, wherein the template is adapted to receive a drag-and-drop input to embed content widgets within the content areas of the template, wherein the content widgets form a template structure in the content areas upon being dropped in the content area, and wherein the template structure is rearrangeable by receiving input adding or removing content widgets.

5. The method of claim 2, wherein at least one of the plurality of tools comprises a container tool adapted to form a template structure in the content areas of the template, wherein the template is adapted to receive a drag-and-drop input embedding a container within the content areas, and wherein the container is adapted to receive one or more of the plurality of content widgets disposed therein by the drag-and-drop input.

6. The method of claim 5, wherein the one or more of the plurality of content widgets are adapted to conform to a size of the container.

7. The method of claim 6, wherein the template structure is rearrangeable by receiving input adding or removing containers comprising content widgets disposed therein.

8. The method of claim 2, wherein at least one of the plurality of tools comprises a browser view tool adapted to format the template to a browser window, wherein a width of the template may be either fixed or flexible based on the browser window dimensions.

9. The method of claim 8, wherein the flexible width is determined by a variable number of pixels from a vertical edge of the browser window.

10. The method of claim 1, wherein the template comprising a plurality of content areas further comprises: a header, a footer, a left gutter, and a right gutter.

11. The method of claim 10, wherein the header, footer, and left and right gutters are adapted to be shown or hidden based on an input received.

12. The method of claim 1, wherein the template further comprises an organic layout adapted to retain a plurality of preset proportions by continually adjusting content to conform with the plurality of preset proportions.

13. A non-transitory computer-readable storage medium, storing instructions that when executed by a processor, cause the processor to build a customizable website, by performing the steps of:
providing a website builder;
providing a template comprising a plurality of content areas;
providing a plurality of content widgets;
receiving input selecting one or more content areas;
receiving input selecting one or more content widgets; and
receiving input of a selected content area for placement of the selected one or more content widgets.

14. The non-transitory computer-readable storage medium of claim 13, wherein the website builder comprises a plurality of tools adapted to configure the template and the content areas.

15. The non-transitory computer-readable storage medium of claim 14, wherein at least one of the plurality of tools comprises a content widget tool adapted to embed content widgets within the content areas of the template.

16. The non-transitory computer-readable storage medium of claim 15, wherein the template is adapted to receive a drag-and-drop input to embed content widgets within the content areas of the template, wherein the content widgets form a template structure in the content areas upon being dropped in the content area, and wherein the template structure is rearrangeable by receiving input adding or removing content widgets.

17. The non-transitory computer-readable storage medium of claim 14, wherein at least one of the plurality of tools comprises a container tool adapted to form a template structure in the content areas of the template, wherein the template is adapted to receive a drag-and-drop input embedding a container within the content areas, and wherein the container is adapted to receive one or more of the plurality of content widgets disposed therein by the drag and drop input.

18. The non-transitory computer-readable storage medium of claim 17, wherein the one or more of the plurality of content widgets are adapted to conform to a size of the container.

19. The non-transitory computer-readable storage medium of claim 18, wherein the template structure is rearrangeable by receiving input adding or removing containers comprising content widgets disposed therein.

20. The non-transitory computer-readable storage medium of claim 14, wherein at least one of the plurality of tools comprises a browser view tool adapted to format the template to a browser window, wherein a width of the template may be either fixed or flexible based on the browser window dimensions.

21. The non-transitory computer-readable storage medium of claim 20, wherein the flexible width is determined by a variable number of pixels from a vertical edge of the browser window.

22. The non-transitory computer-readable storage medium of claim 13, wherein the template comprising a plurality of content areas further comprises: a header, a footer, a left gutter, and a right gutter.

23. The non-transitory computer-readable storage medium of claim 22, wherein the header, footer, and left and right gutters are adapted to be shown or hidden based on an input received.

24. The non-transitory computer-readable storage medium of claim 13, wherein the template further comprises an organic layout adapted to retain a plurality of preset proportions by continually adjusting the content to conform with the plurality of preset proportions.

25. A computer system for building a customizable website, comprising:
a processor; and
a memory storing instructions that, when executed by the processor, cause the computer system to:
provide a website builder;
provide a template comprising a plurality of content areas;
provide a plurality of content widgets;
receive input selecting one or more content areas;
receive input selecting one or more content widgets; and
receive input of a selected content area for placement of the selected one or more content widgets.

26. The computer system of claim 25, wherein the website builder comprises a plurality of tools adapted to configure the template and the content areas.
